(19) United States
(12) Patent Application Publication
(10) Pub. No.: US 2026/0217977 A1
(43) Pub. Date: Jul. 30, 2026

(54) BIODEGRADABLE PLANT PROTEIN HYDROGELS, USES AND PREPARATION THEREOF

(71) Applicant: TECHNION RESEARCH & DEVELOPMENT FOUNDATION LIMITED, Haifa (IL)

(72) Inventors: Nadav AMDURSKY, Haifa (IL); Amit Kumar SARKAR, Haifa (IL)

(21) Appl. No.: 19/144,946

(22) PCT Filed: Jan. 4, 2024
(86) PCT No.: PCT/IL2024/050015

§ 371 Date: Jun. 30, 2025

Related U.S. Application Data
(60) Provisional application No. 63/436,905, filed on Jan. 4, 2023.

(51) Int. Cl. C08L 89/00; C08H 1/00

(52) U.S. Cl. CPC C08L 89/00; C08H 1/00

(57) ABSTRACT

A solid hydrogel material comprising a plant-based protein and the agent is provided, wherein the agent is selected from a carboxylic acid and glycol or combination thereof. Further, articles comprising the hydrogel of the invention are also provided.

### CROSS REFERENCE TO RELATED APPLICATIONS

This application claims the benefit of priority of U.S. Provisional Patent Application No. 63/436,905, filed Jan. 4, 2023, entitled “BIODEGRADABLE PLANT PROTEIN HYDROGELS, USES AND PREPARATION THEREOF”, the contents of which are incorporated herein by reference in their entirety.

### FIELD OF THE INVENTION

The invention relates generally to the field of polymeric hydrogels and articles comprising same.

### BACKGROUND

Fossil-derived plastic is an inseparable part of our modern lives. The uncontrolled exponential production of plastic to meet its demands is associated with ineffective waste management turns plastic into a curse to our environment, becoming the most widespread persistent pollutant on this planet. Plastic-waste pollution is so severe that once it is produced, never be back to its end-of-life option. Apart from suffocating our rivers and oceans when plastics are in their original form, even after breaking down plastics form micro- or nano-plastics. These degraded forms of plastics create a global crisis by contaminating our foods, air, and water, and finally amplifying climate change.

To address this plastic-waste crisis, in particular, the design and development of sustainable plastics is a paradigm shift in replacing fossil-derived plastics. Sustainable plastics can be synthesized from either bio-derived synthetic or non-synthetic starting materials. Non-biodegradable sustainable plastics are synthesized mainly via chemical polymerization using synthetic bio-derived monomers such as biomass-extracted ethylene or butylene succinate. On the contrary, biodegradable sustainable plastics, often known as bioplastic, are developed using non-synthetic nature-derived biomass-extracted starting materials in the form of polymers such as polysaccharides and proteins. Depending on the synthesis strategies such as chemical polymerizations or crosslinking reactions, bioplastics can be prone to hydrolysis and become biodegradable which eventually eradicates the plastic-waste crisis to implicate the regulatory measures of zero waste circular economy.

Polysaccharides and proteins are the building blocks for bioplastics since they are extracted from natural renewable feedstocks, incorporating the bioplastics being biodegradable without any further consequences of polluting the environment. Unlike polysaccharides where only one or in some cases more than one monomer can deliver the building block of bioplastics, proteins offer controlled repetitive sequenced chains of amino acids with non-covalent structural interactions. This structural property of proteins can enable sequenced chains of amino acids to self-assemble inherently and result in the formation of a bioplastic. Among proteins, plant-derived proteins are of specific interest over animal-derived proteins since plant-derived proteins are extracted from plant-based waste in abundance and in a sustainable manner.

Plant-derived proteins offer interesting features such as biodegradation, wide availability, and even safe when it is consumed, therefore, they can be considered a promising building block. However, the majority of plant-derived proteins suffer limited solubility in water which restricts their wide exploitation in the formulation of mechanically robust bioplastics. To overcome this hurdle of water solubility, plant-derived proteins have been processed using either single or mixed solvent-based formulation strategies. These strategies involve organic solvents, binary mixtures of acids or bases with heating or sonication, and using crosslinkers or additives. Although plant-derived proteins accentuate a great potential in developing a bioplastic, the currently used methodologies involve complex processing steps and lack of water-based formulation strategies and eventually bring the environmental impact of a bioplastic to being sustainable.

To enable the design of formulation of sustainable bioplastic, we must consider the environmental impact of the developed bioplastic. This environmental impact of a bioplastic corresponds with using of less toxic or non-toxic chemicals, and environment-friendly solvents with an easy and energy-efficient formulation approach, by which our environment cannot be polluted after the biodegradation of the respective bioplastic. At the same time, the developed bioplastics are mechanically robust for on-demand applications for smart packaging or beauty/cosmetic appliances. Therefore, a suitable balance is required in developing a bioplastic using energy-proficient green chemistry principles with safer biodegradation routes and ease to use for their on-demand applications.

### SUMMARY

The following embodiments and aspects thereof are described and illustrated in conjunction with systems, tools and methods which are meant to be exemplary and illustrative, not limiting in scope.

In one aspect, there is a hydrogel, comprising a protein and an agent selected from (i) alpha hydroxy-carboxylic acid, and (ii) a compound represented by Formula 1:

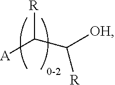

or both (i) and (ii); wherein:
A is selected from

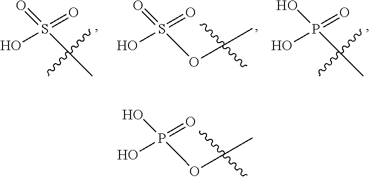 [SMILES: *S(=O)(=O)O ; *OS(=O)(=O)O ; *P(=O)(O)O ; *OP(=O)(O)O]

and carboxy; R is H or represents one or two substituent each independently selected from C1-10 alkyl, C1-10 haloalkyl, C1-10 hydroxyalkyl, C1-6 aminoalkyl, C1-6 mercaptoalkyl, and a substituted C1-10 alkyl; a ratio between the protein and the agent is between 50:1 and 2:1.

In one embodiment, the hydrogel is a solid material and is characterized by a water content of the hydrogel between 3 and 10% w/w; and wherein the protein is substantially devoid of a covalent crosslinking.

In one embodiment, a w/w concentration of the agent within the hydrogel is between about 0.5 and about 40%.

In one embodiment, the protein is selected from a plant protein and an animal protein.

In one embodiment, the plant protein is a plant protein isolate selected from: pea, soybean, chickpea, potato, garbanzo, fava beans, yellow pea, rice, rye, golden lentil, chana dal, sorghum, sprouted green lentil, du pung style lentil, white lima bean, hemp, corn, rapeseed and canola isolate including any fraction or any combination thereof.

In one embodiment, the animal protein is an animal albumin protein.

In one embodiment, the alpha hydroxy-carboxylic acid is C1-C10 alpha hydroxy-carboxylic acid, including any salt thereof; and wherein the plant protein comprises a plant albumin.

In one embodiment, the agent comprises any one of (i) the alpha hydroxy-carboxylic acid selected from glycolic acid and lactic acid, (ii) isethionic acid or both (i) and (ii).

In one embodiment, the secondary structure of the plant protein has a combined beta sheets and beta turns content of at least 50%.

In one embodiment, the hydrogel further comprises up to 10% w/w of an alcohol.

In one embodiment, the alcohol content of the hydrogel is between 100 ppm and about 1% w/w.

In one embodiment, the alcohol is methanol.

In one embodiment, the hydrogel is biodegradable, compostable or both.

In one embodiment, the hydrogel is characterized by a first XRD peak having a 2θ value between about 7 and about 11°, and a second XRD peak having a 2θ value between about 18 and about 22°.

In another aspect, there is provided an article comprising the hydrogel of the invention.

In one embodiment, the article is in a form of a film or in a form of a container.

In one embodiment, the film is characterized by at least one of: light transparency of at least 50%, a tensile strength of at least 1.7 MPa, Young's modulus between 80 to 450 MPa or any combination thereof.

In one embodiment, the film is characterized by an elongation at break of at least 40%.

In one embodiment, the article is in a form of a packaging material or a packaging article.

In another aspect, there is provided a method for manufacturing the article of the invention, comprising: mixing a first aqueous composition comprising the protein and a second aqueous composition comprising the agent, to obtain a flowable composition; shaping the flowable composition under appropriate conditions, thereby forming the article; wherein the shaping is by molding or casting.

In one embodiment, the mixing is performed at a temperature between 25° C. and 90°.

In one embodiment, the molding or casting is by contacting the flowable composition with a mold having a surface characterized by water contact angle of at least 80°.

In one embodiment, a concentration of the protein within the first aqueous composition is between 1 and 20% w/w.

In one embodiment, a w/w ratio between the protein and the agent within the flowable composition is between 50:1 and 2:1.

In one embodiment, the concentration of the agent within the second aqueous composition is between 0.1 and 10% w/w.

In another aspect, there is a hydrogel, comprising a plant protein and an agent selected from a mono-carboxylic acid; wherein a ratio between the plant protein and the agent is between 10:1 and 1:1; and wherein the plant protein is substantially non-crosslinked.

In some embodiments, a water content of the hydrogel is between 3 and 10%.

In some embodiments, a w/w concentration of the agent within the hydrogel is between about 10 and about 40%.

In some embodiments, the plant protein is selected from: pea, soybean, chickpea, potato, garbanzo, fava beans, yellow pea, rice, rye, golden lentil, chana dal, sorghum, sprouted green lentil, du pung style lentil, white lima bean, hemp, corn, rapeseed, canola including any fraction or any combination thereof.

In some embodiments, the mono-carboxylic acid is C1-C10 alpha hydroxy-carboxylic acid, including any salt thereof.

In some embodiments, the mono-carboxylic acid is glycolic acid, lactic acid, or both.

In some embodiments, a secondary structure of the plant protein has a combined beta sheets and beta turns content of at least 50%.

In some embodiments, the hydrogel further comprising up to 10% w/w of an alcohol.

In some embodiments, the alcohol content of the hydrogel is between 100 ppm and about 1% w/w.

In some embodiments, the alcohol is methanol.

In some embodiments, the hydrogel is biodegradable.

In another aspect, there is provided an article comprising the hydrogel of the invention.

In some embodiments, the article is in a form of a film or in a form of a container.

In some embodiments, the film is characterized by at least one of: light transparency of at least 50%, a tensile strength of at least 1.7 MPa, Young's modulus between 80 to 450 MPa, or any combination thereof.

In some embodiments, the film is characterized by an elongation at break of at least 40%.

In some embodiments, the article is in a form of a packaging material or a packaging article.

In another aspect, there is provided a method for manufacturing the article of the invention, comprising: mixing a first aqueous composition comprising the plant protein and a second aqueous composition comprising the agent, to obtain a flowable composition; shaping the flowable composition under appropriate conditions, thereby forming the article; wherein shaping is by molding or casting.

In some embodiments, mixing is performed at a temperature between 25° C. and 900.

In some embodiments, molding or casting is performed by contacting the flowable composition with a mold characterized by water contact angle of at least 80°.

In some embodiments, a concentration of the plant protein within the first aqueous composition is between 1 and 10% w/w.

In some embodiments, a concentration of the agent within the second aqueous composition is between 0.5 and 10% w/w.

In some embodiments, a w/w ratio between the plant protein and the agent within the flowable composition is between 10:1 and 1:1.

In addition to the exemplary aspects and embodiments described above, further aspects and embodiments will become apparent by reference to the figures and by study of the following detailed description.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIGS. 1A-1C are graphs and bar graphs presenting structural characterization of the exemplary films of the invention. 1A: FTIR spectra at different stages of processing during the generation of the SoyP film. 1B: Time-dependent in situ FTIR analysis of the drying process starting from the SoyP-GlyA suspension (top) until film formation (bottom) focusing on the water-associated O—H absorption area. 1C: Time-dependent in situ XRD analysis of the drying process starting from the SoyP-GlyA suspension (bottom) until film formation (top).

FIGS. 2A-2D. are graphs and images presenting mechanical and morphological properties of the exemplary films of the invention. 2A: Tensile stress-strain testing of the SoyP film. 2B: XRD pattern of a strained SoyP film. SEM micrographs presenting analysis of SoyP powder (2C) and cross-sectioned SoyP film (2D). Scale bars in 2C and 2D represent m.

FIGS. 3A-3D are graphs and images of an exemplary alcohol-treated film of the invention. 3A: comparative analyses of water uptake as a function of time of the SoyP film before and after MeOH treatment. 3B: SEM image of the cross-section of a MeOH-treated SoyP film. 3C: Comparative FTIR spectra of the SoyP film before and after MeOH treatment. 3D: Tensile stress-strain testing of the MeOH-treated SoyP film.

### DETAILED DESCRIPTION

The invention is some embodiments thereof is based on a surprising finding that a molded composite film composed essentially of a protein (e.g. a plant protein, or BSA) and an agent comprising a hydroxy-acid, has sufficient mechanical strength and transparency to be utilized as a biodegradable packaging material.

### Hydrogel

According to one aspect there is provided a hydrogel comprising a protein and an agent selected from (i) a hydroxy-carboxylic acid, and (ii) a compound represented by Formula 1:

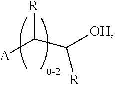

or both (i) and (ii), wherein A is selected from

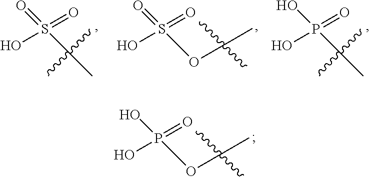 [SMILES: *S(=O)(=O)O ; *OS(=O)(=O)O ; *P(=O)(O)O ; *OP(=O)(O)O]

and R is H or represents one or two substituent each independently selected from C1-10 alkyl, C1-10 haloalkyl, C1-10 hydroxyalkyl, C1-6 aminoalkyl, C1-6 mercaptoalkyl, and a substituted C1-10 alkyl.

In some embodiments, the agent comprises the compound of Formula 1, wherein each R is H, and A is as described above. In some embodiments, the agent comprises the compound of Formula 1, wherein each R is H or C1-10 alkyl (e.g. methyl, ethyl, butyl, etc.).

In some embodiments, the agent comprises a compound represented by Formula 2:

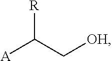

wherein A is selected from

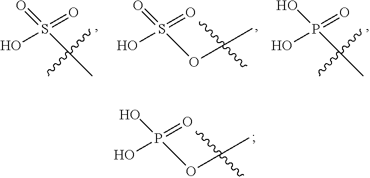 [SMILES: *S(=O)(=O)O ; *OS(=O)(=O)O ; *P(=O)(O)O ; *OP(=O)(O)O]

and R is H or C1-10 alkyl.

In some embodiments, a weight per weight (w/w) ratio between the protein and the agent within the hydrogel is between 50:1 and 1:1, between 50:1 and 2:1, between 50:1 and 3:1, between 50:1 and 4:1, between 50:1 and 5:1, between 50:1 and 10:1, between 40:1 and 10:1, between 30:1 and 1:1, between 30:1 and 10:1, between 30:1 and 20:1, between 30:1 and 5:1, between 50:1 and 20:1, between 10:1 and 1:1, between 6:1 and 4:1, between 5.5:1 and 3:1, between 5:1 and 4:1, between 6:1 and 2:1 and between 5:1 and 1:2, including any range or value therebetween.

In some embodiments, the hydrogel comprises a protein and an agent selected from (i) a hydroxy-carboxylic acid, and (ii) a compound represented by Formula 1, or both (i) and (ii), and wherein weight per weight (w/w) ratio between the protein and the agent within the hydrogel is between 50:1 and 2:1.

The term “hydrogel” refers to a solid comprising a supramolecular structure of self-assembled polymeric molecules (i.e. protein molecules) and water. The term “hydrogel” as used herein, further encompasses a non-flowable (i.e. non-fluid) composition being in a solid or a semi-solid state (such as at a temperature between 0 and 50, between 0 and 40, between 0 and 35° C., or up to a temperature of 70° C., 60° C., 50° C., 40° C., including any range between).

In some embodiments, the supramolecular structures are in a form of a three-dimensional network of polymeric molecules. In some embodiments, the protein molecules are homogenously distributed (e.g., dispersed) within the hydrogel, and are substantially devoid of precipitation. In some embodiments, the hydrogel is in a form of a biphasic mixture, or in a form of a polymeric matrix (i.e. a matrix formed by protein chains) stably bound to the water molecules. In some embodiments, the hydrogel is in a form of a bi-continuous phase (e.g. comprising a layered polymeric matrix and water molecules located in the interphase between the layers). In some embodiments, the protein molecules are substantially devoid of clusters or precipitations. Thus, the protein molecules within the hydrogel of the invention are substantially in a form of distinct molecules, so that the hydrogel is devoid of protein precipitations or curded protein (e.g. with a particle size above 10 nm), and/or protein microparticles (e.g. with a particle size above 1 um, above 20 um, above um, including any range between. The protein within the hydrogel of the invention is further characterized by a distinct secondary structure, relative to the pristine plant protein, as disclosed herein below.

In some embodiments, the hydrogel is in a form of a continuous and/or homogeneous matrix, being substantially devoid of microparticles. In some embodiments, the hydrogel is in a form of a continuous and/or homogeneous matrix, being substantially devoid of protein microparticles.

In some embodiments, the hydrogel is characterized by porosity between 0.1 and 10%, between 1 and 10%, between 1 and 5%, between 0.1 and 5%, between 5 and 10%, including any range between, or at most 10%, at most 7%, at most 5%, at most 3%, or at most 2%.

In some embodiments, a percentage of secondary beta structures (i.e., beta sheets and beta turns) from the total secondary structures of the protein within the hydrogel of the invention is at least 47%, at least 50%, at least 52%, at least 55%, between about 50 and 80%, between about 55 and 80%, between about 55 and 70%, between about 55 and 75%, between 55 and 60%, between 60 and 70%, between 70 and 75% and between 70 and 80%, including any range in between. In some embodiments, the protein within the hydrogel of the invention is characterized by a ratio between secondary beta structures and (i) α-helix or (ii) random coil between 1.1:1 and 1.5:1, between 1.1:1 and 1.4:1, between 1.1:1 and 1.3:1, between 1.1:1 and between 1.2:1 including any range in between. Secondary structures percentages are calculated based on FTIR peak intensities at the following wavelengths: β-sheet (1610-1630 cm-1), α-helix or random coil (1630-1660 cm-1), β-turn (1660-1690 cm-1).

In some embodiments, a percentage of α-helix from the total secondary structures of the protein within the hydrogel of the invention is at most 40%, at most 35%, at most 30%, or between 15 and 40%, between 15 and 35%, between 20 and 40%, between 20 and 35%, including any range between.

In some embodiments, the hydrogel of the invention is characterized by a first XRD peak having a 2θ value between about 7 and about 11°, between about 7 and about 8°, between about 7 and about 9°, between about 8 and about 10°, including any range between; and by a second XRD peak having a 2θ value between about 18 and about 22°, between about 18 and about 20°, between about 19 and about 22°, between about 19 and about 21°, including any range between.

The hydrogel of the invention is flowable (or is in a fluid state) upon dilution thereof with a sufficient amount of water. In some embodiments, sufficient amount is at least 200%, at least 300%, at least 500%, at least 700%, at least 1000% water by weight of the hydrogel. Furthermore, the hydrogel of the invention is substantially devoid of coagulated proteins. In some embodiments, the hydrogel is in a form of amorphous gel, semi crystalline gel, crystalline gel, or hydro colloid gel. In some embodiments, the hydrogel is an amorphous gel.

In some embodiments, the hydrogel of the invention further comprises water. In some embodiments, the hydrogel comprises water, wherein the water is bonded by physical interactions (e.g. hydrogen bonding, dipole-dipole interactions, electrostatic interactions, etc.) to the protein, and/or to the agent. In some embodiments, the hydrogel, and/or the article of the invention is water absorbable, or water swellable. In some embodiments, the hydrogel, and/or the article is configured to absorb up to 450%, up to 400%, up to 350%, up to 300%, up to 250%, up to 150%, up to 50% w/w water (relative to the initial weight of the hydrogel/article) including any range or value therebetween.

In another aspect, there is provided a composite comprising a protein and an agent selected from (i) a hydroxy-carboxylic acid, (ii) the compound of Formula 1, or both (i) and (ii). In some embodiments, a weight per weight (w/w) ratio between the protein and the agent within the composite is between 50:1 and 1:1, between 50:1 and 1:1, between 50:1 and 10:1, between 40:1 and 10:1, between 30:1 and 1:1, between 30:1 and 10:1, between 30:1 and 20:1, between 30:1 and 5:1, between 50:1 and 20:1, between 10:1 and 1:1, between 6:1 and 4:1, between 5.5:1 and 3:1, between 5:1 and 4:1, between 6:1 and 2:1 and between 5:1 and 1:2, including any range or value therebetween.

The term “composite” as used herein refers to a material (e.g. a solid material or a non-flowable material) in a form of a homogenous mixture of two or more constituents (e.g. the protein and the agent of the invention), wherein the constituents a stably bound to each other and cannot be separated by conventional means. The composite is characterized by distinct physical properties (e.g. elasticity, elongation at break, mechanical strength, etc.) as compared to the physical properties of the individual constituents.

In some embodiment, the protein is selected from a plant protein and an animal protein. In some embodiment, the protein is an albumin (e.g. plant albumin, and/or animal albumin).

In some embodiment, the animal protein is selected from a milk protein (e.g. a whey protein, casein, lactoglobulin), a serum protein, egg protein (e.g., Ovalbumin, ovotransferrin, ovomucoid), collagen and gelatin, including any protein isolate, or any combination thereof.

In some embodiment, the animal protein comprises a mammalian protein. In some embodiment, the mammalian protein comprises a serum protein. In some embodiment, the mammalian protein comprises a mammalian albumin protein, or a mammalian serum albumin protein. In some embodiment, the mammalian protein comprises bovine serum albumin (BSA).

In some embodiment, the plant protein is selected from: pea, soybean, chickpea, potato, garbanzo, fava beans, yellow pea, rice, rye, golden lentil, chana dal, sorghum, sprouted green lentil, du pung style lentil, white lima bean, hemp, corn, rapeseed, canola including any fraction or any combination thereof. In some embodiment, the plant protein is a protein isolate.

In some embodiment, the plant protein is a protein isolate selected from: pea, soybean, chickpea, potato, garbanzo, fava beans, yellow pea, rice, rye, golden lentil, chana dal, sorghum, sprouted green lentil, du pung style lentil, white lima bean, hemp, corn, rapeseed, and canola isolate including any combination thereof. In some embodiment, the plant protein is a plant albumin isolate.

In some embodiment, the plant protein is characterized by high content of side-chain carboxy amino acids, e.g. aspartic (Asp) and glutamic (Glu) acid. In some embodiment, the high content comprises a relative abundance (by weight) of side-chain carboxy amino acids within a protein of at least 20%, at least 25%, at least 26%, at least 27%, or between 20 and 40%, between 25 and 40%, between 25 and 30% w/w, or any range between. In some embodiment, the plant protein is a natural product. In some embodiment, the plant protein is derived from a natural product. In some embodiments, the term “derived from” encompasses any industrial processing such as purification, isolation, fractionation, chemical modification, etc. In some embodiment, the plant protein is a protein hydrolysate.

In some embodiment, the plant protein isolate is characterized by protein content of at least 80%, at least 85%, at least 90%, at least 95%, or between 80% and 99%, between 80 and 95% w/w, including any range between. In some embodiment, the plant protein isolate further comprises up to 20%, up to 15%, up to 10%, up to 5% impurities (e.g. non-protein plant constituents, such as poly-, oligo-saccharides, chlorophyl, alkaloids, terpenes, etc.).

In some embodiment, the plant protein is selected from: pea, soybean, and chickpea isolate, or any combination thereof.

In some embodiments, the w/w percentage of the protein within the hydrogel ranges between 0.5 and 20%, between 0.5 and 5%, between 0.5 and 3%, between 3 and 5%, between 5 and 7%, between 7 and 10%, between 10 and 15%, between 15 and 20%, including any range or value therebetween.

In some embodiments, the agent is devoid of any one of glycol, an aromatic carboxylic acid, citric acid, maleic acid, glycine, succinic acid, glycerol, 1,2,3,4-butanetetracarboxylic acid.

In some embodiments, the agent is a hydroxy carboxylic acid. In some embodiments, the hydroxy carboxylic acid is an alpha hydroxy carboxylic acid. In some embodiments, the alpha hydroxy carboxylic acid is an aliphatic alpha hydroxy carboxylic acid.

Non-limiting examples of aliphatic alpha hydroxy carboxylic acids include but are not limited to: glycolic acid, lactic acid, and 2-hydroxybutanoic acid.

In some embodiments, the agent is selected from (i) glycolic acid, lactic acid, and (ii) isethionic acid, or both (i) and (ii).

In some embodiments, the w/w percentage of the agent within the hydrogel ranges between 0.5 and 40%, between 0.5 and 20%, between 0.5 and 10%, between 0.5 and 2%, between 1 and 2%, between 1.5 and 3%, between 0.5 and 3%, between 1.5 and 5%, between 1 and 3%, between 2 and 5%, between 2 and 10%, between 5 and 10%, including any range or value therebetween.

In some embodiments, the agent is a single species.

In some embodiments, the agent is a plurality of chemically distinct species.

In some embodiments, the hydrogel consists essentially of the protein, water, and the agent of the invention. In some embodiments, the hydrogel consists essentially of the protein, water, and the agent of the invention, wherein a w/w ratio between the protein and the agent is between 80:1 and 10:1, between 70:1 and 10:1, between 60:1 and 10:1, between 50:1 and 10:1, between 40:1 and 10:1, between 30:1 and 10:1, between 30:1 and 20:1, between 1:0.75 and 1:0.85, between 1:0.8 and 1:1, including any range in between.

In some embodiments, the hydrogel consists essentially of the protein, water, and the agent of the invention, wherein a w/w percentage of water within the hydrogel is at least 3% and between 3 and 10%, between 3 and 5%, between 5 and 7%, between 7 and 9% and between 8 and 10%, including any range in between.

In some embodiments, the polymeric content of the hydrogel disclosed herein consists essentially of the protein. In some embodiments, the w/w ratio of the polymeric content relative to the dry weight of the hydrogel is between 10 and 95%, between 10 and 90%, between 10 and 85%, between 10 and 80%, between 10 and 30%, between 10 and 20%, between 10 and 50%, between 10 and 40%, between 10 and 60%, between 10 and 70%, between 5 and 40%, between 5 and 30%, between 5 and 20%, between 5 and 50%, between 5 and 60%, between 5 and 70%, including any range between.

In some embodiment, the hydrogel of the invention, and or any of the articles/compositions comprising thereof is/are substantially biocompatible or biodegradable, and/or bioerodible. In some embodiments, the term “biodegradable” describes a substance which can decompose under environmental condition(s) into breakdown products. In some embodiments, the term “biodegradable” as used in the context of embodiments of the invention, also encompasses the term “bioerodible”, which describes a material/composition/article which decomposes under environmental conditions into smaller fractions, thus substantially losing its structure and/or mechanical properties. In some embodiments, the term “bioerosion” refers to erosion of the polymeric hydrogel material initiated by water (e.g. by dissolution), microorganisms, enzymes, etc., and resulting in at least partial degradation of the composition/article comprising the bioerodible material. In some embodiments, the hydrogel or the article of the invention is compostable.

Such environmental conditions include, for example, exposure to any one of water, hydrolytic enzyme activity, microorganism, etc. Wherein the term “degradable” describes a substance which degrades, decomposes, or undergoes erosion under environmental conditions, such that at least 50, at least 70, at least 90 weight percent within a time period less than 2 years (y), less than 1 y, less than 0.5 y, less than 1 month including any range between. Thus, losing its three-dimensional structure and/or mechanical properties.

In some embodiments, the biodegradable of the hydrogel or article of the invention is chemically decomposed under environmental conditions within a time period of between 1 day and 1 month, calculated based on CO2 emission.

In some embodiments, the pH of the hydrogel is at a range from 2 to 8, from 2 to 3, from 2.5 to 3.5, from 3.5 to 5.5, from 5.5 to 7, from 6 to 8, from 5.5 to 6, from 5 to 6.5 including any range or value therebetween. Each possibility represents a separate embodiment of the invention.

In some embodiments, the hydrogel further comprises an active agent incorporated therewithin, wherein the active agent and the concentration thereof within the hydrogel is as between 0.01 and 20, between 0.01 and 1, between 0.1 and 2, between 1 and 2, between 2 and 5, between 5 and 10, between 10 and 15, between 15 and 20, including any range between.

The term “active agent” refers to a small molecule (e.g. biocide, pesticide, insecticide, fungicide etc.). In some embodiments, the term “small molecules” refers to molecules up to 1 kDa.

In some embodiments, the hydrogel further comprises one or more additives (e.g. colorant, UV blocker, stabilizer, antioxidant, preservative, buffering agent etc.), wherein the active agent and the concentration thereof within the hydrogel is as between 0.01 and 20, between 0.01 and 1, between 0.1 and 2, between 1 and 2, between 2 and 5, between 5 and 10, between 10 and 15, between 15 and 20, including any range between.

In some embodiments, the hydrogel is devoid of covalent cross-links. In some embodiments, the w/w concentration of covalently cross-linked protein within the hydrogel is at most 0.25%, at most 0.5%, at most 0.75%, at most 1%, including any range in between.

The term “cross-linking” as used herein refers to the formation of a chemical bond between two chemical moieties or groups. In some embodiments, cross-linking comprises inter cross-linking (e.g. wherein the chemical moieties are distinct protein chains). In some embodiments, cross-linking comprises intra cross-linking (e.g. wherein the chemical moieties are within the same protein chain).

### Article

In another aspect there is provided an article comprising the hydrogel of the invention. In some embodiments, the hydrogel is in a form a single layer, or a plurality of layers. In some embodiments, the hydrogel is in a form of a continuous layer, such as a film.

In some embodiments, the film is a mono-layer. In some embodiments, the film is a multilayer. In some embodiments, the film layer, is in a form of a continuous layer.

The term “continuous layer” or the term “layer” refers to a substantially homogeneous substance of substantially uniform-thickness which maintains its physico-chemical properties (e.g. mechanical strength, elasticity, Young's modulus, chemical composition, water content) with the entire dimensions (lengths and width dimensions) thereof. In some embodiments, each layer has a different physical structure and/or a different chemical composition. In some embodiments, each layer has the same physical structure and/or the same chemical composition. In some embodiments, the term “layer”, refers to a protein layer.

In some embodiments, the hydrogel is in a form of a film, wherein the protein molecules are at least partially bound via physical (non-covalent) bonds. In some embodiments, the physical bonding is by intramolecular bonds, wherein electrostatic interactions between the positively and negatively charged amino acids of the protein with the hydroxyl and/or carboxyl/sulfonate/sulfate/phosphate groups (a plurality of moieties capable of forming a non-covalent bond) of the agent (e.g. glycolic acid, lactic acid, etc.) forming an alternated secondary structure of the protein.

In some embodiments, the article of the invention is a film.

In some embodiments, the article comprises or is in a form of one or more layer(s), wherein each of the one or more layer(s) is characterized by a thickness between 10 μm and 500 μm, between 100 μm and 1000 μm, between 1 mm and 10 mm, between 2 mm and 5 mm, between 5 μm and 200 μm, between 1 mm and 5 mm, including any range or value therebetween. Each possibility represents a separate embodiment of the invention.

The term “thickness” refers to the dry thickness. As used herein, the term “dry thickness” refers to the thickness of the dried article layer (e.g. upon substantial evaporation or removal of water). Dried article layer refers to a layer in a solid state (e.g. non-flowable layer, substantially retaining its shape and/or dimensions upon tilting thereof).

In some embodiments, a water content of the dried article layer is between 3 and 15%, between 3 and 7%, between 5 and 7%, between 5 and 10%, between 5 and 15%, between 10 and 15%, and between 7 and 9%, w/w, including any range or value therebetween.

In some embodiments, the article is a continuous layer. In some embodiments, the layer is in a form of strips or bands. In some embodiments, the continuous layer is in a form of a net. In some embodiments, the layer is in a form of intertwined yarns, threads, fibers or strips.

In some embodiments, the article thickness is between 0.1 and 1 mm, between 0.1 and 0.5 mm, between 0.5 and 2 mm, between 1 and 10 mm, between 2.5 and 5 mm, and between 0.5 cm and 5 cm, including any range or value therebetween.

In some embodiments, the oxygen permeability of the article of the invention is between 70 and 100%, between 80 and 90%, between 90 and 99% and between 95 and 99%, including any range or value therebetween. In some embodiments, the water vapor permeability of the article is between 75 and 150 g/m² day, between 90 and 150 g/m² day, between 75 and 100/m² day, between 100 and 200 g/m² day, between 125 and 200 g/m² day, between 100 and 150/m² day, between 125 and 250/m² day and between 100 and 300/m² day including any range or value therebetween.

In some embodiment, the article is characterized by light transparency between 50 and 100%, between 95 and 99%, between 70 and 100%, between 70 and 90%, between 50 and 70% including any range or value therebetween.

In some embodiment, the article is characterized by a tensile strength of at least 1 MPa, at least 1.5 MPa, at least about 1.5 MPa, at least about 2 MPa, including any range between. In some embodiment, the article is characterized by a tensile strength between 1.5 and 20 MPa, between 1.5 and 2.5 MPa, between 1.5 and 5 MPa, between 2 and 10 MPa between 2 and 20 MPa, between 5 and 15 MPa, including any range or value therebetween.

In some embodiment, the article is characterized by a Young's modulus of at least 80 MPa and between 85 and 450 MPa, between 85 and 150 MPa, between 150 and 200 MPa, between 200 and 300 MPa, between 300 and 375 MPa and between 375 and 450 MPa, including any range or value therebetween.

In some embodiment, the article is characterized by elongation at break at least about 50%, at least about 100%, at least about 200%, at least about 250%, at least about 300%, between 35 and 500%, between 50 and 100%, between 35 and 1000%, between 50 and 1000%, between 50 and 150%, between about 50 and about 350%, between about 50 and about 500%, between 100 and 150%, between 100 and 200%, between 100 and 250%, between 100 and 300%, between 100 and 500%, between 300 and 500%, between 350 and 500%, and between 100 and 500%, including any range or value therebetween.

In some embodiments, the article of the invention is characterized by visible light transmission (VLT) between 80% and 99%, between 82% and 99%, between 85% and 99%, between 89% and 99%, between 90% and 99%, between 95% and 99%, between 80% and 95%, between 82% and 95%, between 85% and 95%, between 89% and 95%, between 90% and 95%, between 80% and 90%, between 82% and 90%, or between 85% and 90%, including any range therebetween. Each possibility represents a separate embodiment of the invention. As used herein “visible light transmission (VLT)” refers to a measurement of the amount of visible light waves that transmit through a material.

In some embodiment, the article further comprises trace amounts of alcohol (e.g. methanol, ethanol, etc.) In some embodiments, the alcohol comprises C1-C10 alcohol, including any combination, or including any salt thereof. In some embodiments, the alcohol comprises a C1-C5 alcohol, wherein C1-C5 alcohol comprises 5 carbon atoms, 4 carbon atoms, 3 carbon atoms, 2 carbon atoms and 1 carbon atom. In some embodiment, a w/w percentage of alcohol within the hydrogel is between 10 ppm and 10%, between 10 ppm and 1%, between 10 ppm and 0.1%, between 100 ppm and 5%, between 100 ppm and 1%, between 100 ppm and 0.1%, between 100 ppm and 0.01%, including any range or value therebetween.

In some embodiments, the C1-C10 alcohol is one or more of methanol, ethanol, propanol, iso-propanol, butanol, including any combination, or including any salt thereof.

In some embodiments, the alcohol is methanol.

In some embodiments, the article consists essentially of the protein, water, the agent of the invention, and trace amounts of alcohol wherein a ratio or a w/w percentage of the protein, water, the agent of the invention, within the article is as described hereinabove (see Hydrogel section).

In some embodiments, the protein and/or water within the article and the alcohol are bonded by physical interactions (e.g. hydrogen bonding, dipol-dipol interactions, electrostatic interactions, etc.).

In some embodiments, the article/hydrogel comprising trace amounts of alcohol is characterized by reduced porosity; wherein reduced porosity comprises at least 20%, at least 30%, at least 50%, at least 70% lower porosity as compared to the same article devoid of trace amounts of alcohol.

In some embodiments, the article comprising trace amounts of alcohol is characterized by narrow XRD peaks, having a peak width at a baseline below 2°, below 1°, below 0.5°, between 0.1 and 3°, between 0.5 and 3°, between 0.5 and 2°, between 0.1 and 1°, including any range or value therebetween.

In some embodiments, the article consists essentially of the protein, water, the agent of the invention, and trace amounts of alcohol and is characterized by advantageous properties, such as: Young's modulus between 85 and 450 MPa and a tensile strength between 1.5 and 20 MPa.

In some embodiments, the article devoid of trace amounts of alcohol is characterized by water absorption capability (i.e. swellability) of up to 450%, up to 400%, up to 350%, up to 300%, up to 250%, up to 150%, up to 50%, between 50 and 500%, between 50 and 450%, between 100 and 500%, between 100 and 400%, between 200 and 400% w/w, between 200 and 300% w/w water (relative to the initial weight of the article) including any range or value therebetween.

In some embodiments, the article comprising trace amounts of alcohol is characterized by water absorption capability (i.e. swellability) of up to 200%, up to 170%, up to 180%, between 50 and 200%, between 100 and 200%, between 150 and 200% w/w water (relative to the initial weight of the article) including any range or value therebetween.

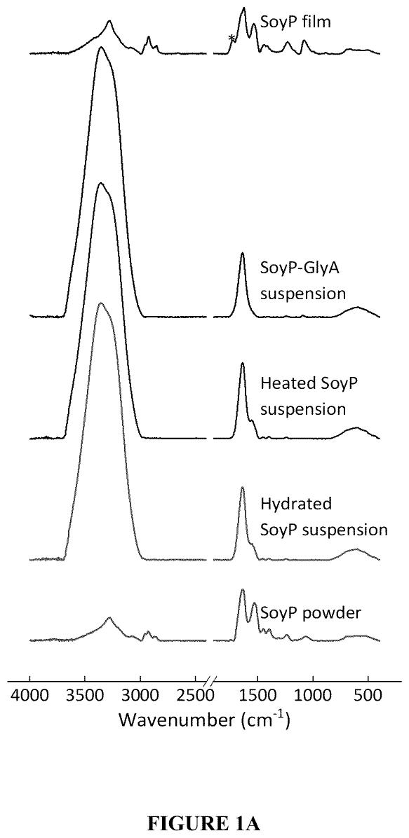

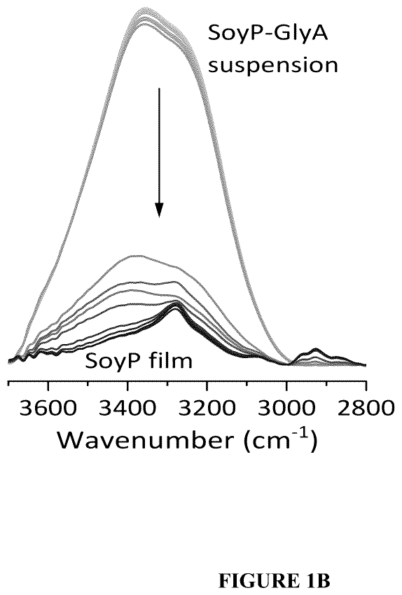

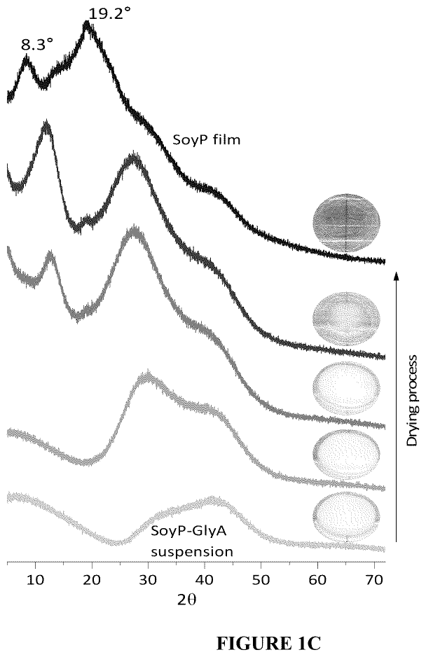

In some embodiments, the article of the invention comprising a hydroxy-carboxylic acid as the agent is characterized by an FTIR peak at a wavelength between 1715 and 1735 cm-1, corresponding to a carboxy group of the hydroxy-carboxylic acid. In some embodiments, the article, is characterized by FTIR peak at a wavelength about 1725 cm-1, or between about 1720 cm-1 and about 1730 cm-1, and wherein FTIR spectrum of the pristine protein is devoid of the peak corresponding to a carboxy group (i.e. a peak at a wavelength of about 1725 cm-1). A non-limiting FTIR spectrum of an exemplary article of the invention is demonstrated in FIG. 1.

In some embodiments, the article of the invention is characterized by a higher percentage of secondary beta sheet structures within the article compared to a pristine protein. In some embodiments, the percentage of secondary beta structures (i.e., beta sheets and beta turns) from the total secondary structures of the protein within the article is at least 47%, at least 50%, at least 52%, at least 55%, between about 50 and 80%, between about 55 and 80%, between about 55 and 70%, between about 55 and 75%, between 55 and 60%, between 60 and 70%, between 70 and 75% and between 70 and 80%, including any range between. In some embodiments, the protein within the article of the invention is characterized by a ratio between secondary beta structures and random coil between 1.1:1 and 1.5:1, between 1.1:1 and 1.4:1, between 1.1:1 and 1.3:1, between 1.1:1 and between 1.2:1 including any range in between. Secondary structures percentages are calculated based on FTIR peak intensities at wavelengths of about 1621 and about 1693 (beta-sheet), about 1648 (random coil) and about 1682 (beta-turn) cm⁻¹.

In some embodiments, the article further comprises an active agent, wherein a w/w concentration of the active agent within the article is between 0.01 and 20%, between 0.01 and 10%, between 0.01 and 5%, between 0.01 and 10%, between 0.1 and 20%, between 0.1 and 10%, between 1 and 5%, between 5 and 20%, between 5 and 10%, between 10 and 20%, between 0.01 and 1%, between 10 and 20%, including any range or value therebetween.

In some embodiments, the active agent is bonded via physical interactions to the protein and/or incorporated therewithin (without being limited to a specific theory).

In some embodiments, the article of the invention is in a form of a sheet, a film article, a packaging article, an agricultural article, or any combination thereof.

In some embodiments, the article of the invention (e.g. a film article) is stretched in at least one direction. In some embodiments, the article of the invention is stretched along a longitudinal axis of the article (also used herein as Machine Direction Orientation). In some embodiments, stretching ratio of the stretched article is between 1:2 to 1:7, between 1:2 to 1:3, between 1:3 to 1:7, between 1:4 to 1:7, between 1:5 to 1:7, including any range between.

In some embodiments, the stretched article of the invention is in a semi-crystalline state. In some embodiments, the stretched article is characterized by a crystallinity of at least 1.5 times, at least 3 times, at least 5 times, at least 7 times, at least 10 times greater than the crystallinity of an un-stretched article as measured by normalized intensity of at least one peak in XRD.

In one aspect of the invention, there is provided an article comprising the hydrogel of the invention. In some embodiments, the article is selected from a film, a ribbon, a package, a wound dressing. In some embodiments, the article is a continuous film.

In some embodiments, the article is in a form of a container, wherein the container comprises at least one wall the article. In some embodiments, the wall comprises or consists essentially of the hydrogel of the invention.

In some embodiments, the hydrogel of the invention and/or the article/composition comprising thereof is substantially devoid of unbound or un-complexed water.

In some embodiments, any one of the articles disclosed herein is selected from transparent plastic surfaces, a package (e.g., food package, medical device package, agricultural package, and biological sample package.

In some embodiments, the hydrogel or the composite of the invention is in a form of a shaped article. In some embodiments, the shaped article is a molded or a casted article. The terms “shaped article” and “article” are used herein interchangeably. In some embodiments, the article is manufactured or shaped by a method selected from casting, hot melt processing, and molding, or any combination thereof.

In some embodiments, the wall is characterized by a thickness between 1 μm and 500 μm, 1 μm and 200 μm, 1 μm and 100 μm, 2 μm and 500 μm, 2 μm and 200 μm, 5 μm and 500 μm, 5 μm and 200 μm, between 10 and 20 μm, between 10 and 100 μm, between 10 and 200 μm, between 20 and 40 μm, between 40 and 50 μm, between 50 and 60 μm, between 60 and 70 μm, between 70 and 80 μm, between 80 and 90 μm, between 90 and 100 μm, between 10 and 500 μm, between 100 and 200 μm, between 200 and 500 μm, including any range or value therebetween. Each possibility represents a separate embodiment of the invention.

In some embodiments, the term “thickness” refers to the dry thickness of the wall, as described herein. In some embodiments, the wall further comprises an active agent, wherein the active agent is as described herein, and a w/w concentration of the active agent within the and/or within the article is between 0.01 and 20%, including any range between as described hereinabove. In some embodiments, the article is substantially stable (e.g. substantially retains its physical properties, mechanical strength, and/or substantially retains the initial content of the active agent) upon prolonged storage under conditions comprising (i) a temperature ranging between −40° C. and 70° C., between −40° C. and 40° C., between −40° C. and 30° C., between −40° C. and 0° C., between 0° C. and 70° C., between 0° C. and 30° C., between 30° C. and 70° C., 30° C. and 50° C., between 50° C. and 70° C., including any range between; (ii) moisture between 0 and 90%, or between 0 and 50%, including any range between and (iii) exposure to atmospheric conditions, such as an ambient atmosphere, and ambient pressure for a time period of at least 1 m, at least 2 m, at least 3 m, at least 4 m, at least 5 m, at least 7 m, at least 10 m, at least 1 y, at least 2 y, including any range between.

As used herein the term “stable” refers to the capability of the article to maintain its structural and/or mechanical integrity. In some embodiments, the article is referred to as stable, if the article is characterized by a mechanical integrity sufficient to be used as a packaging material. In some embodiments, the article is referred to as stable, if the article substantially maintains its structural and/or mechanical integrity under outdoor conditions such as a temperature −25 and 75° C., rain, moisture, UV and/or visible light irradiation for a time period of at least 12 months, as described hereinabove. In some embodiments, the stable article is rigid under outdoor conditions. In some embodiments, the stable article at least 50% of its initial tensile strength and/or elasticity. In some embodiments, the term “initial” is immediately after the manufacturing of the article prior to exposure to the storage conditions and/or outdoor conditions. In some embodiments, substantially is as described hereinbelow.

In some embodiments, the article (e.g. in a form of a sheet, a ribbon, a thread or a film) is characterized by elongation at break between 30 and 1500%, between 30 and 40%, between 40 and 60%, between 60 and 800%, between 80 and 100%, between 100 and 150%, between 125 and 175%, between 100 and 300%, between 200 and 350%, between 300 and 400%, between 350 and 450%, between 400 and 600%, between 500 and 1000%, between 100 and 500%, between 500 and 700%, between 700 and 1000%, between 1000 and 1500%, between 1000 and 1200%, between 1200 and 1500% including any range or value therebetween.

In some embodiments, the article (e.g. in a form of a sheet, a ribbon, a thread or a film) is characterized by mechanical strength (e.g. abrasion stability, tear stability, peel off stability, etc.) sufficient for use thereof as a plant article, a packaging article, or both. In some embodiments, the article is characterized by tensile strength of at least 0.5 MPa, and between 0.5 and 80 MPa, between 0.5 and 1.5 MPa, between 0.5 and 5 MPa, between 1.5 and 5 MPa, between 1.5 and 8 MPa, between 5 and 15 MPa, between 1.5 and 80 MPa, between 15 and 80 MPa, and between 15 and 50 MPa, including any range between.

In some embodiments, the article (e.g. in a form of a sheet, a ribbon, a thread or a film) is characterized by tensile strength up to about 1 MPa, up to about 3 MPa, up to about 5 MPa, up to about 8 MPa, up to about 10 MPa, up to 15 MPa, up to 20 MPa, including any range between, wherein the article consists essentially of the hydrogel of the invention (e.g. devoid of the polymeric substrate in contact with the hydrogel).

In some embodiments, the article comprising a w/w ratio between protein and agent of between about 1:0.1 and 1:1, between 1:0.15 and 1:0.25, between 1:0.25 and 1:0.5, between 1:0.5 and 1:0.75, between 1:0.75 and 1:0.85, between 1:0.8 and 1:1, including any range in between, is characterized by preferable mechanical properties of the resulting article. as compared to a similar article having a w/w ratio between protein and agent of below 1:0.1 or above 1:1.

In some embodiments, the article (e.g. in a form of a sheet, a ribbon, a thread or a film) is characterized by elasticity sufficient for use thereof as a packaging article. In some embodiments, the article is characterized by sufficient elasticity so as to obtain any predefined shape. In some embodiments, the article (e.g. in a form of a sheet, a ribbon, a thread or a film) is characterized by elasticity sufficient for obtaining the shape of the wrapped matter (such as an edible matter, a package, a crop material, etc.). In some embodiments, the article (e.g. in a form of a sheet, a ribbon, a thread or a film) substantially retains its shape for a time period disclosed herein.

In some embodiments, the hydrogel and/or the article of the invention is characterized by a self-healing ability. In some embodiments, the self-healing ability comprises self-adhesiveness of the hydrogel and/or the article, i.e. the films of the invention undergo adhesion upon contacting of the films with each other (and optionally applying a compression force).

### Manufacturing Process

In another aspect, there is provided a method for manufacturing the article of the invention, the method comprises (i) mixing a first aqueous composition comprising the protein and a second aqueous composition comprising the agent of the invention at appropriate conditions thereby forming the flowable composition (iii) shaping the flowable composition under appropriate conditions thereby forming the article.

In some embodiments, the appropriate conditions are conditions suitable for casting or molding (e.g., cast molding, compression molding), such as a temperature between 20 to 40° C., between 20 to 25° C., between 25 to 30° C., between 30 to 35° C., between 35 to 40° C., and optionally applying a sufficient pressure. Exact conditions suitable for casting or molding are well known in the art.

In some embodiments, the method further comprises a preliminary step of forming (i) the first aqueous composition, comprising dispersing the protein is in water, to obtain the first aqueous composition and (ii) the second aqueous composition, comprising the agent in water, to obtain the second aqueous composition.

In some embodiments, dispersing comprises a w/w ratio of the protein and water between 1:100 and 1:5, between 1:20 and 1:12, between 1:20 and 1:10, between 1:50 and 1:12, between 1:50 and 1:5, between 1:50 and 1:10, between 1:20 and 1:14, including any range or value therebetween.

In some embodiments, dispersing is performed at temperature between 2° and 100° C., between 2° and 25° C. between 2° and 50° C. between 25 and 50° C. between 5° and 70° C. between 7° and 100° C., between 7° and 90° C., between 2° and 90° C., including any range in between.

In some embodiments, the second aqueous composition comprises a w/w ratio of the agent and water between 1:1000 and 1:10, between 1:500 and 1:10, between 1:500 and 1:100, between 1:200 and 1:70, between 1:200 and 1:10, between 1:200 and 1:100, between 1:200 and 1:50, between 1:200 and 1:40, between 1:80 and 1:40, between 1:80 and 1:20, between 1:80 and 1:65, including any range or value therebetween. In some embodiments, the second aqueous composition is devoid of a buffering agent. In some embodiments, the second aqueous composition is a non-buffered composition/solution. In some embodiments, the second aqueous composition consists essentially of the agent and water, and is devoid of a buffering ability.

In some embodiments, the flowable composition is formed by mixing the first and the second aqueous compositions (i) for a period of time of at least 0.5 h, at least 1 h, at least 1.5 h, at least 2 h, at least 3 h, at least 4 h including any range in between (ii) at a temperature between 2° and 100° C., between 2° and 25° C. between 2° and 50° C. between 25 and 50° C. between 5° and 70° C. between 7° and 100° C., between 7° and 90° C., between 2° and 90° C., including any range in between.

In some embodiments, a w/w concentration of (i) the protein within the flowable composition is between 1 and 20%, between 1 and 10%, between 3 and 10%, between 5 and 10%, between 5 and 20%, including any range between; and (ii) the agent within the flowable composition is between 0.1 and 10%, between 0.1 and 5%, between 0.1 and 1%, between 0.1 and 2%, between 0.1 and 3%, between 0.2 and 3%, between 0.2 and 1%, between 0.2 and 0.5%, including any range between.

In some embodiments, the mixing step (i) is performed by adding the second aqueous compositions to the first aqueous compositions, or by adding the first aqueous compositions to the second aqueous compositions. In some embodiments, the mixing step (i) is performed by contacting the second aqueous compositions to the first aqueous compositions simultaneously.

In some embodiments, the shaping step (ii) is by molding or casting, wherein the molding or casting is by contacting the mixture with a mold characterized by a water contact angle of at least 80°, of at least 85, of at least 90°, of at least 100°, of at least 110°, of at least 1200 including any range in between.

In some embodiments, casting or molding is conducted at a temperature between 20 to 40° C., between 20 to 25° C., between 25 to 30° C., between 30 to 35° C., between 35 to 40° C., including any range in between. In some embodiments, casting or molding process is performed for a time sufficient for substantial water evaporation, and formation of a transparent article. In some embodiments, casting or molding process induces a water evaporation-assisted self-assembly.

In some embodiments, the present invention provides combined preparation. In one embodiment, “a combined preparation” defined especially a “kit of parts” in the sense that the combined partners as defined above can be packaged or stored independently or by use of different fixed combinations with distinguished amounts of the combination partners i.e., simultaneously, concurrently, separately, or sequentially.

In some embodiments, the kit comprises: (i) a first compartment comprising the protein as disclosed herein; and (ii) a second compartment comprising the agent of the invention, wherein a ratio between the protein and the agent within the kit is between 50:1 and 1:1, between 50:1 and 2:1, between 50:1 and 3:1, between 50:1 and 5:1, between 50:1 and 5:1, between 50:1 and 10:1, between 50:1 and 20:1, between 30:1 and 20:1, between 30:1 and 10:1, between 10:1 and 1:1, between 10:1 and 5:1, between 10:1 and 2:1, between 10:1 and 3:1, between 8:1 and 2:1, between 8:1 and 3:1, including any range between. In some embodiments, anyone of the first compartment, and the second compartment, optionally further comprises a surfactant, or an additive, or a solvent, or a stabilizer or any combination thereof. In some embodiments, the first compartment consists of the plan protein in a form of powder, and the second compartment consists of the agent.

In some embodiments, the first compartment is an aqueous composition comprising the protein at a w/w concentration between 1 and 20%, between 1 and 10%, between 1 and 5%, between 2 and 10%, between 3 and 10%, between 3 and 7%, between 1 and 7%, between 1 and 20%, between 1 and 15%, between 5 and 10%, between 5 and 20%, including any range between. In some embodiments, the second compartment comprises a w/w concentration of the agent between 0.1 and 10%, between 0.1 and 5%, between 0.1 and 8%, between 0.1 and 3%, between 0.1 and 1%, between 0.1 and 0.5%, between 1 and 10%, between 1 and 5%, between 5 and 10%, including any range between. In some embodiments, the kit comprises instructions for mixing the first compartment and the second compartment of the kit at a ratio sufficient to obtain the flowable composition of the invention. In some embodiments, the kit comprises instructions for mixing the first compartment and the second compartment of the kit at a ratio sufficient to obtain the flowable composition of the invention characterized by a w/w ratio between the protein and the agent of between 60:1 and 1:1, between 60:1 and 2:1, between 50:1 and 1:1, between 50:1 and 2:1, between 50:1 and 3:1, between 50:1 and 5:1, between 50:1 and 10:1, between 50:1 and 20:1, between 30:1 and 20:1, between 30:1 and 10:1, including any range between.

In some embodiments, the kit further comprises a third compartment comprising an aqueous solution or an alcohol. In some embodiments, the aqueous solution of the third compartment comprises water, or an aqueous buffer, and optionally a surfactant, and additive and a stabilizer.

In some embodiments, the kit comprises instructions for mixing together any one of the first compartment and the second compartment, with the third compartment. In some embodiments, the instructions further comprise a ratio between the first compartment and the third compartment so as to obtain the aqueous composition comprising the protein at a w/w concentration between 0.5 and 30%, between 1 and 20%, between 1 and 10%, between 3 and 10%, between 5 and 10%, between 5 and 20%, including any range between.

In some embodiments, the instructions further comprise a ratio between the second compartment and the third compartment so as to obtain the aqueous composition comprising the agent at a w/w concentration between 0.1 and 30%, between 0.1 and 20%, between 0.1 and 10%, between 0.1 and 5%, between 0.1 and 1%, between 0.1 and 2%, between 0.1 and 3%, between 0.2 and 3%, between 0.2 and 1%, between 0.2 and 0.5%, including any range between.

In some embodiments, the instruction further provides suitable conditions for mixing, such as mixing time of between 0.5 and 5 h and a temperature between 2° and 100° C. In some embodiments, the suitable conditions are as described in the methods section.

In some embodiments, mixing the components can be done, simultaneously or sequentially.

### Definitions

In some embodiments, the composition is in the form of, but not limited to, a liquid, gel, solid or biofumigant.

In one embodiment, the present invention provides combined preparations. In one embodiment, “a combined preparation” defines especially a “kit of parts” in the sense that the combination partners as defined above can be dosed independently or by use of different fixed combinations with distinguished amounts of the combination partners i.e., simultaneously, concurrently, separately or sequentially. In some embodiments, the parts of the kit of parts can then, e.g., be administered simultaneously or chronologically staggered, that is at different time points and with equal or different time intervals for any part of the kit of parts. The ratio of the total amounts of the combination partners, in some embodiments, can be administered in the combined preparation. In one embodiment, the combined preparation can be varied, e.g., in order to cope with the needs of a patient subpopulation to be treated or the needs of the single patient which different needs can be due to a particular disease, severity of a disease, age, sex, or body weight as can be readily made by a person skilled in the art.

### General

As used herein the term “about” refers to +10%. Further, all numerical values, e.g. when referring the amounts or ranges of the elements constituting the formulation are approximations which are varied (+) or (−) by up to 10% of from the stated values. It is to be understood, even if not always explicitly stated that all numerical designations are preceded by the term “about”.

The terms “comprises”, “comprising”, “includes”, “including”, “having” and their conjugates mean “including but not limited to”.

In the description and claims of the present application, each of the verbs, “comprise”, “include” and “have” and conjugates thereof, are used to indicate that the object or objects of the verb are not necessarily a complete listing of components, elements or parts of the subject or subjects of the verb.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure. The term “consisting essentially of” is used to define formulations which include the recited elements but exclude other elements that may have an essential significance on the formulation. The term “consisting essentially of” refers to at least 80%, at least 85%, at least 90%, at least 92%, at least 95%, at least 97%, at least 99% (or any range between) by dry weight of the composition/hydrogel/article disclosed herein, is composed of the specific constituent(s) listed above.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict. The word “optionally” and the word “further” are used herein interchangeably. The terms, film/films and layer/layers are used herein interchangeably. As used herein, the term “coat” refers to the combined layers disposed over the substrate, excluding the substrate, while the term “substrate” refers to the part of the composite structure supporting the disposed layer/coating. In some embodiments, the terms “layer”, “film” or as used herein interchangeably, refer to a substantially uniform-thickness of a substantially homogeneous substance.

As used herein, the singular form “a”, “an” and “the” include plural references unless the context clearly dictates otherwise. For example, the term “a compound” or “at least one compound” may include a plurality of compounds, including mixtures thereof.

As used herein, the term “substituted” or the term “substituent” are related to one or more (e.g. 2, 3, 4, 5, or 6) substituents, wherein each of the one or more substituent(s) is independently selected from hydrogen, halogen, —NO₂, —CN, —OH, oxo, amino, thioxo, carbonyl, imino, —(C═O)NH2, —CONR′₂, —CNNR′₂, —CSNR′₂, —CONH—OH, —CONH—NH₂, NHCOR′, —NHCSR′, —NHCNR′, —NC(═O)OR, —NC(═O)NR′, —NC(═S)OR′, —NC(═S)NR′, —SO₂R′, —SOR′, —SR′, —SO₂OR′, —SO₂N(R′)₂, —NHNR′₂, —NNR′, C₁-C₆ haloalkyl, optionally substituted C₁-C₆ alkyl, —NH₂, —NR′₂—NH(C₁-C₆ alkyl), —N(C₁-C₆ alkyl)₂, C₁-C₆ alkoxy, C₁-C₆ haloalkoxy, hydroxy(C₁-C₆ alkyl), hydroxy(C₁-C₆ alkoxy), alkoxy(C₁-C₆ alkyl), alkoxy(C₁-C₆ alkoxy), C₁-C₆ alkyl-NR′₂, C₁-C₆ alkyl-SR′, —CONH(C₁-C₆ alkyl), —CON(C₁-C₆ alkyl)₂, —CO₂H, —CO₂R′, —OCOR, —OCOR′, —OC(═O)OR′, —OC(═O)NR′, —OC(═S)OR′, —OC(═S)NR′, or a combination thereof, wherein each R′ independently represents hydrogen, or is selected from the group comprising optionally substituted C₁-C₁₀ alkyl, optionally substituted C₁-C₃₀ alkyl, optionally substituted C₁-C₃₀ alkenyl, optionally substituted C₁-C30 alkynyl, optionally substituted C₃-C₁₀ cycloalkyl, optionally substituted C₃-C₁₀ heterocyclyl, optionally substituted heteroaryl, optionally substituted aryl, hydroxy, amino, —NH₂, —NR′₂—NH(C₁-C₆ alkyl), —N(C₁-C₆ alkyl)₂, C₁-C₆ alkoxy, C₁-C₆ haloalkoxy, hydroxy(C₁-C₆ alkyl), hydroxy(C₁-C₆ alkoxy), alkoxy(C₁-C₆ alkyl), alkoxy(C₁-C₆ alkoxy), C₁-C₆ alkyl-NR′₂, C₁-C₆ alkyl-SR′, or a combination thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

In some embodiments, the term “reducing”, or any grammatical derivative thereof, indicates that at least 20%, 30%, 40%, 50%, 60%, 70%, 80%, 90%, or more, reduction of growth or even complete growth inhibition in a given time as compared to the growth in that given time of the pathogen not being exposed to the treatment as described herein. In some embodiments, the term “completely inhibited”, or any grammatical derivative thereof, refers to 100% arrest of growth in a given time as compared to the growth in that given time of the pathogen not being exposed to the treatment as described herein. In some embodiments, the terms “completely inhibited” and “eradicated” including nay grammatical form thereof, are used herein interchangeably.

Other terms as used herein are meant to be defined by their well-known meanings in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

### Materials

Soy protein (SoyP) and pea protein (PeaP) were purchased from MP Biomedicals and Pisane-Cosucra, respectively. Glycolic acid (GlyA) was purchased from Glentham Life Sciences. All experiments were performed under Milli-Q water.

### Methods

Synthesis of the protein films.

To make the protein film, 7 wt % of the protein powder (either SoyP or PeaP) was dispersed in water at 50° C. and stirred for 30 minutes to form an aqueous suspension. This aqueous protein suspension was mixed with an aqueous stock solution containing 1.75 wt % GlyA (glycolic acid) at 50° C., resulting at a final concentration of GlyA of about 0.2 wt. %. When GlyA was added, the dispersion transformed into a milky-white appearance. Stirring was continued at 50° C. for an additional 30 minutes. The milky-white dispersion of protein was drop-cast onto a plastic-made petri dish and kept there until water evaporation for several hours (depending on the volume used) and transformation into a transparent protein film.

### FTIR Measurements.

A Bruker Tensor spectrometer with an attenuated total reflectance (ATR) accessory was used for FTIR spectroscopy. For each measurement, the atmospheric background contribution was subtracted from the original FTIR spectrum. The FTIR spectra were averaged using the conditions of 4 cm-1 resolution with more than 68 individual scans. The second derivative of each spectrum was processed using the built-in Bruker software available in the instrument and analyzed using OriginPro2023 by deconvoluting the peaks under the amide I region (1600-1700 cm-1) and integrating them.

### X-Ray Scattering Diffraction (XRD) Measurements.

XRD was performed on a Rigaku (SmartLab) high-resolution diffraction system. The system was equipped with a Hypix 3000 detector and beam energy of 1.5406 Å (8.04 KeV). The tests were performed at a 2θ range of 5°-90° in continuous mode with a scan rate of 5 degrees/minute and scan steps of 0.01 degrees using the 1D mode of the detector.

### Scanning Electron Microscopy (SEM) Imaging.

A cryo-SEM sample was prepared by placing ~3 μL of either SoyP suspension or GlyA-treated SoyP suspension between two metallic carriers. This was followed by high-pressure freezing (HPF) vitrification using a Leica EM ICE system. Following thermal fixation, the specimen was fractured at cryogenic temperatures under vacuum (Leica EM ACE900). To enhance contrast, the system allowed the removal of some of the vitrified liquid by sublimation. Transportation of the cryo-specimen was performed with a cooled and evacuated shuttle. Upon completion of the procedure, the specimen on the specimen table was subsequently transferred onto the cryo-stage of the SEM through an airlock. The SEM stage was precooled to −150° C. and maintained at a high vacuum to ensure a contamination-free surface during the observation. The process of sublimating volatiles to improve topographic specimen contrast was performed inside the SEM by raising the temperature to −110° C. for approximately 1 minute. High-resolution SEM imaging was performed on a Zeiss Ultra Plus FEG-SEM with an acceleration voltage of 1 keV, applying a low-dose imaging procedure. The utilization of low-voltage and low-dose imaging was found to be sufficient to keep neutral, even uncoated, nonconductive specimens with minimal radiation damage to the specimen.

### Mechanical Testing

Mechanical testing of the protein films was conducted with cut films with dimensions of 2.5×1×0.02 (length×width×thickness [cm]). The testing apparatus used was TA1, Ametek Instruments, Lloyd materials, equipped with a 50 N load cell. The samples were securely clamped within the mechanical tester and stressed at a constant speed of 2 mm/min until failure. All experiments were performed in triplicate to validate the overall shape of the stress (σ)-strain (ε) curves.

### Water Stability Testing

To test the stability of the SoyP/PeaP film in pure water, films with dimensions of 4×4×0.02 (length×width×thickness [cm]) were submerged in a 50 mL beaker containing 45 mL of water. The hydrated films were collected at predetermined time intervals, and the weight of the hydrated films was recorded.

### Biodegradability (Compostability) Testing.

Films with dimensions of 5×3×0.02 (length×width×thickness [cm]) were placed either on the surface of an agricultural soil or 3 cm deep inside the soil. A commercial plastic control (LDPE plastic) was serving as the control. The appearance of films was recorded digitally with time to check their biodegradation ability. An ISO 14852 protocol was used to study the biodegradation of the protein films within water with an inoculum. This study was carried out under aerobic conditions by measuring the % of biodegradability by the amount of evolved CO₂.

### Example 1

The inventors successfully prepared protein films from soy, pea, and chickpea protein isolates as well as form bovine serum albumin. The following crosslinkers have been successfully implemented in the protein film formation: glycolic acid, lactic acid and isethionic acid. Surprisingly, structurally similar carboxylic acids (which are not alpha-hydroxy carboxylic acids/a compound of Formula 1, such as citric acid, acetic acid, glycine and glycerol didn't result in the formation of a stable protein film. Moreover, without the use of GlyA no stable (e.g. self-supporting) film is formed.

Although GlyA is a weak acid, it lowers the pH of the water solution to below 4, resulting in the protonation of most carboxylic acids in the system. This is possible only when pure water is used, while using a buffer (i.e., preventing the drop in the pH upon adding GlyA) does not allow film formation.

The resulting film was analyzed by infrared spectroscopy and wide angle X-ray scattering (WAXS). Water absorption and mechanical properties of the resulting film were also tested.

### FTIR Characterization the Film

Exemplary ATR-FTIR spectra of soy protein powder and soy protein film of the invention are presented in FIG. 1. First, the inventors used FTIR to gain an insight into the processes the protein's secondary structure undergoes during assembly, from dry powder through the aqueous environment until dry film formation (FIG. 1A). In general, the FTIR spectrum of a protein is sensitive to the >C═O stretching of amide I (~1600-1700 cm-1), the bending of N—H, and the stretching of C—N of amide II (~1500-1600 cm-1), which are all sensitive to the secondary structure of the protein. Additionally, the ~3100-3300 cm-1 region is linked to O—H absorption, associated mainly with the presence of water.

As shown in FIG. 1A, a clear change in the FTIR spectra is observed from the dry SoyP powder to SoyP film via hydrated SoyP suspension and SoyP-GlyA suspension. The indicative amide II peak at 1530 cm⁻¹ for dry SoyP powder became less prominent upon interaction with water at 50° C. Next, the addition of GlyA leads to a complete elimination of this amide II peak. Interestingly, the inventors noticed the regeneration of the amide II peak in the dry SoyP film with an additional hump at ~1725 cm⁻¹, whereas the latter can be ascribed to the incorporation of carboxylic groups from GlyA in the SoyP film. The regeneration of the amide II peak at 1530 cm-1 is accompanied by the loss of water, as can be observed in the time-dependent in situ FTIR measurement during drying, from the protein-GlyA suspension until film formation (FIG. 1B depicts the water regions). The changes in the amide II position (not shown) already indicate a change in the secondary structure during the process.

Without being limited to any particular mechanism, it is postulated that these results confirm a physical interaction between the glycolic acid and the soy protein.

### Percentage of Secondary Structure Present in the Soy Protein Powder a Soy Protein Film

The inventors further used the amide I region (1600-1700 cm-1) to elucidate the protein's secondary structural contributions using a second derivative and deconvoluting the outcome to the well-known characteristic protein conformations for β-sheet, α-helix or random coils, and β-turns. Importantly, the inventors compared only the spectra of the SoyP powder and the final SoyP film as it is not valid to compare dry and hydrated samples using this methodology. The inventors observed that the protein within the film configuration is adopting a more β-sheet-rich secondary structure compared to the starting SoyP powder material. Without being limited to any particular mechanism, it is postulated that the generation of the β-sheet-rich (>52%) secondary structure after treating the soy protein powder with monocarboxylic acid is the driving force for the development of a soy protein film without using any chemical crosslinker.

### XRD of Soy Protein and Pea Protein Film

Immediately after drop-casting, the XRD pattern of the drop-cast GlyA-treated SoyP suspension shows a broad hump corresponding to the amorphous nature of the suspension. From this point, a time-dependent transformation of the XRD pattern has been observed. It begins with the emergence of a semi peak-like appearance at 2θ of ~29° to a newly generated crystalline-like peak at 2θ of ~12° in addition to the peak at ~29°, which becomes narrower, whereas the crystalline peak at ~12° shifts towards even lower 2θ values at longer times. Finally, upon complete water evaporation, the film exhibits well-defined peaks with obtained 2θ values at 8.3° and 19.02°, corresponding to distances of 10.6 Å and 4.6 Å, respectively (FIG. 1C).

The periodicity observed in the final film's XRD study is a result of the ordered secondary structure within the film, formed only upon water evaporation and the self-assembly process (as discussed in the FTIR section). The 10.6 Å and 4.6 Å peaks are well-defined characteristics of ordered β-sheet structures, as also observed in other SoyP-based materials or films using other methodologies. For both soy protein and pea protein films, the crystallinity increases after the mechanical test, because after the mechanical test there are more ordered sequencing of β-sheet structure.

### SoyP/PeaP Self-Assembly to a Transparent Film

Without being bound to any particular mechanism, the inventors postulate that:
It is advantageous using a protein with large percentage (>27%) of carboxylic acid-containing amino acids, aspartic (Asp) and glutamic (Glu) acids.
Slight heating to 50° C. during the first steps is essential.
The nature of the agent: addition of GlyA, an alpha-hydroxy acid, is essential for the self-assembly process. The inventors found that adding lactic acid (the second smallest alpha-hydroxy acid), as well as isethionic acid can also result in film formation. However, adding small non-alpha-hydroxy acids, such as acetic acid or glycine, did not result in similar film formation.
The carboxylic acid-containing residues (Glu/Asp) can form hydrogen bonds, resulting in protein aggregation. This stage is accompanied by an additional change in the protein structure.
Water evaporation assists self-assembly process. When water molecules leave the system, the GlyA molecules can be incorporated between the protein chains. Since GlyA is an alpha-hydroxy acid, both its —OH and —COOH groups can assist in a hydrogen-bond network formation. This step is accompanied by a change in the protein secondary structure to a β-sheet-rich structure. The end result is an ordered assembled film, prompting its transparency.

The films of the invention exhibited two surprising properties of the film. The first property is the film's ability to self-heal. Accordingly, two pieces of the protein film can be healed together. The second property is related to the material on which the film is formed. The inventors observed that when glass or silica is used as the substrate material, the formed film exhibits a very strong adhesion to the substrate. Whereas, the film can be easily removed from the substrate when drop-casting is performed on a hydrophobic substrate, such as plastic or Teflon.

### Example 2

### Mechanical and Morphological Properties

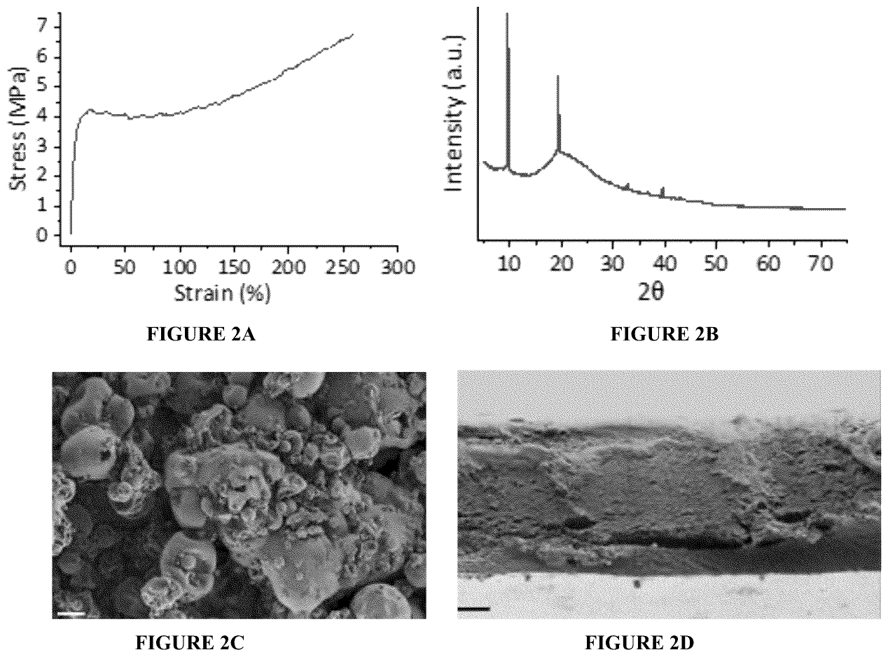

The tensile testing of the protein film displays a nontraditional mechanical property (FIG. 2A). Initially, a sharp increase in stress (up to ~4 MPa) can be observed at relatively small strain values, resulting in a tensile strength of ~7 MPa and a calculated Young's modulus of ~220 MPa. However, after the initial increase in stress, a plateau in measured stress is observed up to strain values of ~110%. Finally, with increasing strain, the inventors observed a second increment of stress until the film reaches its ultimate elongation at a fracture of ~250%. This three-stage pattern in the stress-strain curve is uncommon in protein-based films; however, mechanical-induced transition in protein structure is well known for keratin proteins. Accordingly, the observed three-stage pattern might be related to a structural transition within the film.

To gain further insight into this transition, the inventors follow the XRD pattern after stretching of the film (FIG. 2B). The XRD demonstrates a remarkable formation of highly crystalline peaks, i.e., increasing periodicity at the positions ascribed to the β-sheet structures within the films, only after stretching.

The inventors further follow the FTIR pattern of the SoyP film in the stretching area from the stretched region of the SoyP film, indicating no fundamental difference in the FTIR pattern. By calculating the protein secondary structure components from the FTIR spectra, the inventors observe a minor change in the extracted secondary structure components. Thus, it is postulated that stretching induces an ordering of the structure within the film with no major indications of a change in the secondary structure.

To follow the morphology of the film microstructure, the inventors turned to scanning electron microscopy (SEM). First, the inventors compared the powder at the starting point and the final film configuration, which showed that the microstructures of the two dry forms were different. While the powder has a granular structure (FIG. 2C), the film comprises dense and interconnected thin layers (FIG. 2D for the film cross-section).

### Example 3

### Tuning the Stability of the Protein Film

So far, the inventors have introduced the process for manufacturing a free-standing film composed of dense and interconnected thin layers from an agglomerated protein solution via a hydrogen-bonding-driven self-assembly mechanism. The next immediate question is related to the stability of the film in various conditions, especially taking into consideration the starting material of the film, SoyP/PeaP, and the unique self-assembly process that relies on hydrogen bonding in contrast to conventional covalent crosslinking. The stability of the film is of prime importance, considering the practical viability of our protein bioplastics as a replacement for fossil-fuel-derived plastics. The inventors first explore the stability under ambient conditions (room temperature and humidity) by following the intactness of the protein film placed on a bench in our lab. No noticeable change in the film was found for over a year (and counting); it did not degrade and remained elastic.

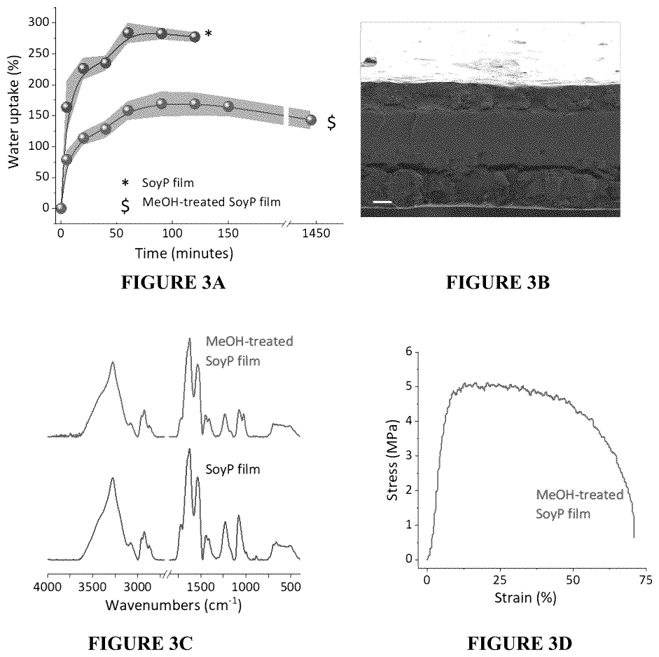

The second important stability assay was performed in water. Due to the involvement of hydrogen bonding in the self-assembly process, water can easily penetrate the film, resulting in rapid and large water uptake of ~150 wt. % within 5 minutes in water and nearly 280 wt. % after 120 minutes (FIG. 3A). During water uptake, and again, due to the involvement of hydrogen bonding in the assembly process, the film starts to collapse, resulting in the dissolution of the film at the end of the measurement into the milky-white agglomerated form of solution.

The inventors further find that the dissolution process of the film can be significantly accelerated using mechanical agitation, resulting in dissolution within several minutes. Importantly, the inventors establish that the film can be easily recycled in this manner. Consequently, by mechanically agitating the film in pure water solution until its dissolution in a few minutes, followed by drop casting, it is possible to reform the film.

The inventors discovered an easy and straightforward step to enhance the aqueous stability of the film by restricting water uptake. To restrict water uptake, the interconnected layer structure of the film must be densified. To this aim, the inventors simply dipped the film in methanol (MeOH) for 10 min, known to strengthen the hydrogen bonding between proteins. Upon MeOH dipping, the inventors found that the film's microstructure had significantly changed, resulting in a much denser film configuration and the interconnected thin layers are not visible anymore (FIG. 3B).

Importantly, the inventors found that the water uptake of the MeOH-treated film is considerably lower than that before the MeOH treatment and that the film maintained its structural integrity for ~2 days within an aqueous environment (FIG. 3a). In terms of protein structure, the inventors compared the FTIR spectrum of the film before and after MeOH dipping, which revealed a generally similar pattern with relatively similar extracted secondary structure components. The dense microstructure of the MeOH-treated film is responsible for different mechanical properties (FIG. 3d). As before (FIG. 2A), the stress-strain curve for the MeOH-treated film also shows a rapid increase in stress followed by the plateau region. However, the MeOH-treated film does not exhibit a three-stage pattern, and following the plateau region, a slow collapse of the mechanical properties at higher strain values is observed. In terms of the mechanical properties, the MeOH-treated SoyP film exhibits a lower tensile strength (~5 MPa), stemming from the different mechanical profiles described above, and a slightly higher Young's modulus (~230 MPa), resulting from changes in the initial stretching process. However, the most profound change in the extracted mechanical properties is the elongation of fracture, exhibiting a ~4-fold decrease after the MeOH treatment directly related to the new nature of the MeOH-treated film being much denser.

### Example 4

### Biodegradability Tests

Biodegradation of the exemplary films of the invention has been tested (i) inside a compost soil and (ii) on top of a compost mixture, wherein degradation of the film was calculated based on CO₂ emission. The films inside the compost soil were fully degraded within 4 days, whereas almost 50% of the films on top of the compost mixture degraded within a similar period of time.

### Biodegradation in Soil Conditions

The first type of biodegradation is in soil conditions, whereas the inventors followed the biodegradation when placing the films inside the soil, thus imitating landfill conditions, and when placing the films on the surface of the soil, thus imitating more ‘real-life’ conditions of plastic disposal. When placed within the soil, the inventors observed a very fast biodegradation profile, whereas after only 4 days, the inventors observed the complete biodegradation of the film. Interestingly, the inventors observed an identical biodegradation profile for the as-prepared film and the MeOH-treated film, even though their degradation profile and water uptake are very different. Unlike the bacteria-rich environment within the soil (as within compost), the environment on the surface of the soil is less rich in bacteria. Nonetheless, on the surface of the soil, the inventors also observed a relatively first biodegradation, whereas the films underwent complete biodegradation after 35 days. As before, there was no difference between the as-prepared film and the MeOH-treated films.

### Biodegradation in an Aqueous Environment

An additional major environmental problem for the use of plastic is concerning their end-of-life aspects when they reach water sources (rivers, lakes, seas, and oceans). In many cases, plastics can be degraded into microplastics, which are not biodegraded and can be dangerous to many life forms. Accordingly, a second biodegradation assay was performed to follow the biodegradation within an aqueous environment containing bacteria. Unlike the biodegradation evaluation within the soil, which was based on the common visual evaluation, here, the inventors followed the amount of CO₂ produced by the bacteria in closed vessels containing the SoyP/PeaP films as the only carbon source in comparison to a common positive control, a cellulose powder (not a film), and a negative blank. The assessment of the amount of CO₂ under aerobic conditions, a standardized method approved by the International Organization for Standardization (ISO), is the standard test for determining the extent of biodegradability of a biodegradable material. While taking into consideration the maximum theoretical CO₂ that can be produced from the carbon source, which was calculated according to the carbon content of the material used and its weight, the inventors could transform the accumulated CO₂ release into a biodegradation percentage. Usually, such biodegradation measurements of biodegradable plastics include a lag time, whereas the bacteria inside the inoculum are adjusted to the new carbon source, followed by a slow or rapid rise in biodegradation rate until it reaches saturation (together, it can take a few months for the film to biodegrade). Biodegradation of the SoyP and PeaP films is very fast (much faster than that of the positive control), not showing a lag phase at all, and it starts to saturate at a value close to 70% after 28 days. The reason for the fast biodegradation of our films is directly related to the processing and morphology non-crosslinked stacked layers of proteins in their native-like structural configuration. Proteins are excellent nutrients for all living things; hence, our films are a great ‘snack’ for bacteria within the soil or in an aqueous environment. The reason that the biodegradation starts to saturate when it reaches 70% can be ascribed to the presence of GlyA in our film, which is ~30% of the carbon source. This means that after the bacteria utilize the proteins at first as the preferred carbon source, they need to ‘switch diet’ to the less-preferred GlyA carbon source.

While the present invention has been particularly described, persons skilled in the art will appreciate that many variations and modifications can be made. Therefore, the invention is not to be construed as restricted to the particularly described embodiments, and the scope and concept of the invention will be more readily understood by reference to the claims, which follow.

1. A hydrogel, comprising a protein and an agent selected from (i) alpha hydroxy-monocarboxylic acid- and (ii) a compound represented by Formula 1: 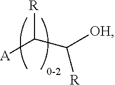
or both (i) and (ii); wherein:
A is selected from 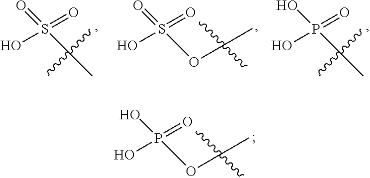 [SMILES: *S(=O)(=O)O ; *OS(=O)(=O)O ; *P(=O)(O)O ; *OP(=O)(O)O]
R is H or represents one or two substituent each independently selected from C1-10 alkyl, C1-10 haloalkyl, C1-10 hydroxyalkyl, C1-6 aminoalkyl, C1-6 mercaptoalkyl, and a substituted C1-10 alkyl; and wherein a ratio between said protein and said agent within the hydrogel is between 50:1 and 2:1.

2. The hydrogel of claim 1, wherein said hydrogel is a solid material and is characterized by a water content of said hydrogel between 3 and 10% w/w; and wherein said protein is substantially devoid of a covalent crosslinking.

3. The hydrogel of claim 1, wherein a w/w concentration of said agent within said hydrogel is between about 0.5 and about 40%.

4. The hydrogel of claim 1, wherein said protein is selected from a plant protein and an animal protein.

5. The hydrogel of claim 4, wherein said plant protein is a plant protein isolate selected from: pea, soybean, chickpea, potato, garbanzo, fava beans, yellow pea, rice, rye, golden lentil, chana dal, sorghum, sprouted green lentil, du pung style lentil, white lima bean, hemp, corn, rapeseed and canola isolate including any fraction or any combination thereof.

6. The hydrogel of claim 4, wherein said animal protein is a animal albumin protein.

7. The hydrogel of claim 1, wherein said alpha hydroxy-monocarboxylic acid is C1-C10 alpha hydroxy-monocarboxylic acid, including any salt thereof; and wherein said plant protein comprises a plant albumin.

8. The hydrogel of claim 1, wherein said agent comprises any one of (i) the alpha hydroxy-monocarboxylic acid selected from glycolic acid and lactic acid, (ii) isethionic acid or both (i) and (ii).

9. The hydrogel of claim 1, wherein a secondary structure of said plant protein has a combined beta sheets and beta turns content of at least 50%.

10. The hydrogel of claim 1, further comprising up to 10% w/w of an alcohol.

11. The hydrogel of claim 10, wherein said alcohol content of said hydrogel is between 100 ppm and about 1% w/w; and wherein said alcohol is methanol.

12. (canceled)

13. The hydrogel of claim 1, wherein said hydrogel is biodegradable, compostable or both.

14. The hydrogel of claim 1, characterized by a first XRD peak having a 2θ value between about 7 and about 11°, and a second XRD peak having a 2θ value between about 18 and about 22°.

15. An article derived from the hydrogel of claim 1.

16. The article of claim 15, wherein said article is in a form of a film, a packaging material, a packaging article or in a form of a container.

17. The article of claim 16, wherein said film is characterized by at least one of: light transparency of at least 50%, a tensile strength of at least 1.7 MPa, Young's modulus between 80 to 450 MPa; elongation at break of at least 40% or any combination thereof.

18. (canceled)

19. (canceled)

20. A method for manufacturing the article of claim 15, comprising:
mixing a first aqueous composition comprising said protein and a second aqueous composition comprising said agent, to obtain a flowable composition;
shaping said flowable composition under appropriate conditions, thereby forming said article; wherein said shaping is by molding or casting.

21. The method of claim 20, wherein said mixing is performed at a temperature between 25° C. and 90°; and wherein said molding or casting is by contacting the flowable composition with a mold having a surface characterized by water contact angle of at least 80°.

22. (canceled)

23. The method of claim 20, wherein a concentration of said protein within said first aqueous composition is between 1 and 20% w/w; wherein a w/w ratio between the protein and the agent within the flowable composition is between 50:1 and 2:1; and wherein a concentration of said agent within said second aqueous composition is between 0.1 and 10% w/w.

24. (canceled)

25. (canceled)
